(19) United States
(12) Patent Application Publication
(10) Pub. No.: US 2025/0063639 A1
(43) Pub. Date: Feb. 20, 2025

(54) FLEXIBLE CONDUCTOR CHANNEL COIL FOR INDUCTION HEATING

(71) Applicant: AJAX TOCCO MAGNETHERMIC CORPORATION, Warren, OH (US)

(72) Inventors: David A. Lazor, Girard, OH (US); Jeffery Phillip Deeter, Warren, OH (US)

(73) Assignee: AJAX TOCCO MAGNETHERMIC CORPORATION, Warren, OH (US)

(21) Appl. No.: 18/808,559

(22) Filed: Aug. 19, 2024

Related U.S. Application Data
(60) Provisional application No. 63/533,284, filed on Aug. 17, 2023.

(51) Int. Cl. H05B 6/42; H05B 6/10

(52) U.S. Cl. CPC H05B 6/42; H05B 6/10

(57) ABSTRACT

An induction heating system for workpieces is provided with a flexible conductor channel coil apparatus for induction heating that can be adjustably opened or closed based on workpiece size. A power supply provides power with controllable voltage and/or current and frequency to the coil apparatus. A cooling fluid supply provides cooling fluid that circulates through the turns of the coil apparatus.

The present application claims the benefit of and priority to U.S. Provisional Application Ser. No. 63/533,284, filed Aug. 17, 2023, which is incorporated herein by reference in its entirety.

### TECHNICAL FIELD

The present exemplary embodiments relate to inductive heating of workpieces. It finds particular application in conjunction with inductive heating of pipes and/or bars, and will be described with particular reference thereto. However, it is to be appreciated that the present exemplary embodiments are also amenable to other like applications.

### BACKGROUND

Inductive heating systems can be used to heat various workpieces such as bars and/or pipes. Such inductive heating systems are typically built, configured, and sized to accommodate a workpiece of a specific size. Thus, changes to the build, configuration, or size of these systems to accommodate workpieces of a different size are impractical, expensive, and/or extremely difficult.

### BRIEF DESCRIPTION

In one aspect of the presently described embodiments, the system comprises a coil apparatus comprising a first fixed turn portion having a first end and a second end, a second fixed turn portion having a first and a second end, a first flexible turn portion having a first end and a second end, and a second flexible turn portion having a first end and a second end, wherein the first flexible turn portion is connected to the first ends of the first fixed turn portion and the second fixed turn portion and the second flexible turn portion is connected to the second ends of the first fixed turn portion and the second fixed turn portion, such that a spacing distance between the first fixed turn portion and the second fixed turn portion is adjustable to accommodate a size of a workpiece to be heated by the coil apparatus, a power supply configured to provide controlled voltage and/or current to the coil apparatus, and a cooling fluid supply configured to circulate cooling fluid in the coil apparatus.

In another aspect of the presently described embodiments, the first fixed turn portion and the second fixed turn portion each comprise at least one electrically conductive structure having an interior cavity configured to allow a flow of the cooling fluid therethrough.

In another aspect of the presently described embodiments, the at least one electrically conductive structure comprises at least one hollow copper tube.

In another aspect of the presently described embodiments, the first flexible turn portion and the second flexible turn portion each comprise at least one flexible electrical conductor structure surrounded by a non-conductive flexible material to allow a flow of the cooling fluid through and/or around the at least one flexible electrical conductor.

In another aspect of the presently described embodiments, the flexible electrical conductor structure comprises at least one of the following: multi-strand braided copper wire or Litz wire.

In another aspect of the presently described embodiments, the non-conductive flexible material comprises a rubber hose.

In another aspect of the presently described embodiments, the system further comprises a workpiece stand or mounting fixture having elements configured to manually adjust the spacing distance.

In another aspect of the presently described embodiments, the system further comprises a workpiece stand or mounting fixture having elements configured to adjust the spacing distance using machine control.

In another aspect of the presently described embodiments, the first fixed turn portion and the second fixed turn portion are configured to conduct electricity, produce electromagnetic fields, and allow circulation of the cooling fluid.

In another aspect of the presently described embodiments, the first flexible turn portion and the second flexible turn portion are configured to conduct electricity and allow circulation of the cooling fluid.

In one aspect of the presently described embodiments, the coil apparatus comprises a first fixed turn portion having a first end and a second end, a second fixed turn portion having a first and a second end, a first flexible turn portion having a first end and a second end, and, a second flexible turn portion having a first end and a second end, wherein the first flexible turn portion is connected to the first ends of the first fixed turn portion and the second fixed turn portion and the second flexible turn portion is connected to the second ends of the first fixed turn portion and the second fixed turn portion, such that a spacing distance between the first fixed turn portion and the second fixed turn portion is adjustable to accommodate a size of a workpiece to be heated by the coil apparatus.

In another aspect of the presently described embodiments, the first fixed turn portion and the second fixed turn portion each comprise at least one electrically conductive structure having an interior cavity configured to allow a flow of the cooling fluid therethrough.

In another aspect of the presently described embodiments, the at least one electrically conductive structure comprises at least one hollow copper tube.

In another aspect of the presently described embodiments, the first flexible turn portion and the second flexible turn portion each comprise at least one flexible electrical conductor structure surrounded by a non-conductive flexible material to allow a flow of the cooling fluid through and/or around the at least one flexible electrical conductor.

In another aspect of the presently described embodiments, the flexible electrical conductor structure comprises at least one of the following: multi-strand braided copper wire or Litz wire.

In another aspect of the presently described embodiments, the non-conductive flexible material comprises a rubber hose.

In another aspect of the presently described embodiments, the spacing distance is adjusted manually.

In another aspect of the presently described embodiments, the spacing distance is adjusted using machine control.

In another aspect of the presently described embodiments, the first fixed turn portion and the second fixed turn portion are configured to conduct electricity, produce electromagnetic fields, and allow circulation of cooling fluid.

In another aspect of the presently described embodiments, the first flexible turn portion and the second flexible turn portion are configured to conduct electricity and allow circulation of cooling fluid.

### BRIEF DESCRIPTION OF THE DRAWINGS

FIGS. 1A and 1B illustrate an example embodiment according to the presently described embodiments;

FIGS. 2A and 2B illustrate an example embodiment according to the presently described embodiments;

FIGS. 3A and 3B are illustrations of example lead ends implemented according to the presently described embodiments; and

FIG. 4 is an illustration of an example of the presently described embodiments and an environment into which the presently described embodiments may be implemented.

### DETAILED DESCRIPTION

According to the presently described embodiments, in at least one form, an induction heating system is provided to accommodate varying sizes of workpieces (e.g., pipes or bars such as metal pipes or bars, or other components/parts that can be inductively heated) that are heated by the system. The system may be implemented in a variety of forms, but several example forms will be described below.

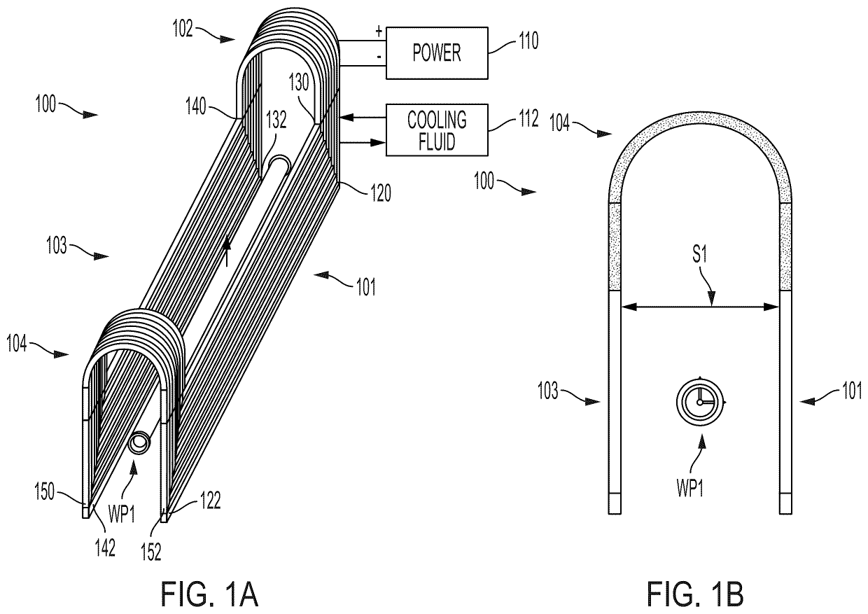

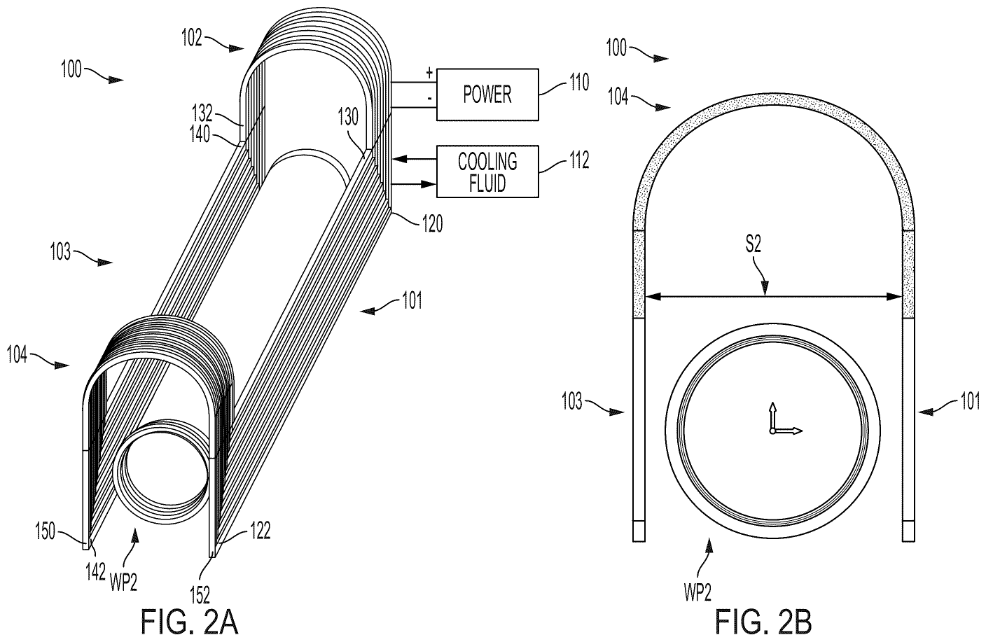

In this regard, FIGS. 1A-2B show an example induction heating system with a flexible conductor channel coil apparatus 100 for induction heating that can be easily opened or closed based on part or workpiece size. A power supply 110 provides, for example, AC power with controllable voltage and/or current and frequency to the coil apparatus 100. A cooling fluid supply 112 provides cooling fluid (e.g., water) that circulates through the turns of the coil apparatus. It should be appreciated that the power supply 110 and the cooling fluid supply 112 are shown in representative form. These elements may be provided to the system and/or implemented in a variety of manners and/or take a variety of suitable forms to achieve the objectives of the presently described embodiments, as those of skill in the art will understand.

The coil apparatus 100 may also take a variety of suitable forms but, in at least one form, includes an integer number N turns configured to provide induction heating of a workpiece, such as WP1 or WP2, when energized by the power supply 110. The coil apparatus 100 is cooled by circulation of cooling fluid from the cooling fluid supply 112. As noted, the cooling fluid supply 112 may be implemented in a variety of suitable manners. For example, the cooling fluid supply 112 may be implemented to provide circulation of cooling fluid, such as water, through a single turn of the coil apparatus 100, multiple turns of the coil apparatus 100, or partial turns of the coil apparatus 100 depending on the implementation and/or desired objectives, as those of skill in the art will appreciate.

The flexible conductor channel coil apparatus 100 provides an adjustable opening channel type inductor with a first fixed turn portion 101 positioned, as shown, generally parallel with the elongated workpiece WP1 in FIG. 1A and WP2 in FIG. 2A. The first fixed portion 101 has a first end 120 and a second end 122. The first end 120 of the first fixed turn portion 101 is connected to a first end 130 of respective flexible turn portion 102, and a second end 132 of the respective flexible turn portion 102 is connected to a first end 140 of respective second fixed turn portion 103. A second end 142 of the second fixed turn portion 103 is connected to a first end 150 of respective flexible turn portion 104, and a second end 152 of the flexible turn portion 104 is connected to the second end 122 of the first fixed turn portion 101. Connections for the power supply 110 and the cooling fluid supply 112 (not shown) can be provided as a break or interruption in the electrical and fluid connections of one of the turns, for example, between a first end of the first fixed turn portion 101 and the first end 130 of the flexible turn portion 102.

The fixed turn portions 101 and 103, in at least one example, are hollow copper tubes or other suitable electrically conductive structures with an interior cavity allowing flow of coolant fluid therethrough. Also, as shown, these fixed portions are stacked on one another or otherwise grouped to create parallel paths of flow. While eight (8) tubes, e.g., copper tubes, are shown, any number of tubes can be used to accommodate any given implementation. Further, any flow configuration could be used. Also, in at least one form, the first fixed turn portion and the second fixed turn portion are configured to conduct electricity, produce electromagnetic fields, and allow circulation of the cooling fluid.

The flexible turn portions 102 and 104, in at least one example, include a flexible electrical conductor structure, such as multi-strand braided copper wire, Litz wire, or other suitable electrical conductor structure surrounded by a nonconductive flexible sheet, such as a rubber hose, to allow the coolant fluid to flow through and/or around the electrical conductor structure. Also, as shown, these flexible portions are stacked on one another or otherwise grouped to create parallel paths of flow. While eight (8) hoses are shown to correspond to the eight (8) copper tubes of each fixed turn portion, any number of tubes can be used to accommodate any given implementation. Further, any flow configuration could be used. Also, in at least one form, the first flexible turn portion and the second flexible turn portion are configured to conduct electricity and allow circulation of the cooling fluid. The first flexible turn portion and the second flexible turn portion, in at least one form, do not produce sufficient electromagnetic fields to be used in the inductive heating process.

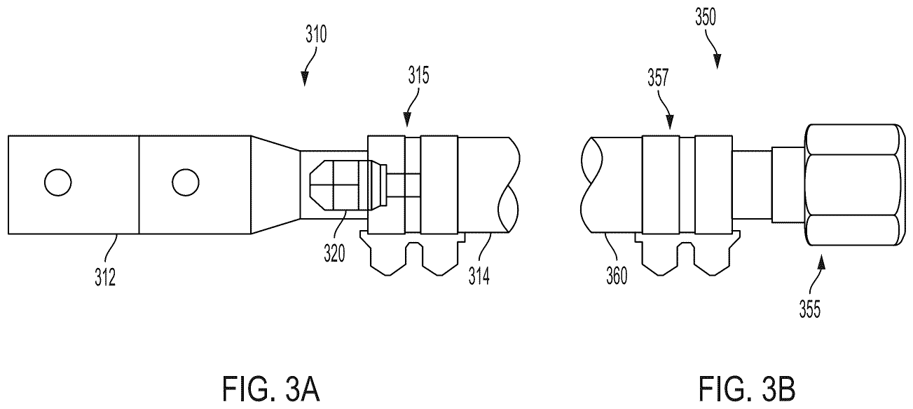

FIGS. 3A and 3B show examples of two suitable lead ends that may be included as part of the ends of the flexible turn portions. As shown in FIG. 3A, a lead end 310 includes a flat portion 312 that may be connected, in at least one form, to the fixed turn portions, e.g., a copper tube. The lead end 310 also includes connection elements 315 to connect to, for example, a rubber hose 314 of the flexible turn portions. In addition, the lead end 310 includes a fluid port 320. This fluid port 320 may be used to facilitate the introduction of water into or the exit/removal of water out of the flexible turn portion. In this regard, the lead end 310 could be used in locations, for example as noted above, where fluid may be removed from the system after circulation through a partial turn, a full turn, or multiple turns. In addition, the fluid port may be used to introduce fluid at suitable locations to achieve desired circulation patterns. Moreover, it should be appreciated that the lead end 310 will allow for further conduction of electricity through the connection. But, the fluid will not circulate through this connection-only be introduced or removed from the port. Referring now to FIG. 3B, a lead end 350 is shown. The lead end 350 will allow for the conduction of electricity and the circulation of fluid through the connection. As shown, the lead end 350 is provided with connection elements 355 to connect to the fixed turn portions, e.g., to a copper tube, and connection elements 357 to connect to, for example, a rubber hose 360 of the flexible turn portions. However, it will be appreciated that connections of a variety of suitable forms between the respective ends of individual fixed and flexible turn portions may be made using any suitable techniques and fixtures/apparatus so as to provide electrical interconnection and fluidic connection or flow to accommodate the flow of coolant fluid through the coil apparatus 100. The device of FIGS. 3A and 3B are merely examples.

Referring back to FIGS. 1A-2B, the flexible turn portions 102 and 104 can be flexed to provide adjustability to accommodate a desired induction heating operation to accommodate different workpiece sizes. The adjustment of the relative positioning of the fixed turn portions 101 and 103 can be done manually and/or automatically, for example, using an adjustable mounting apparatus or fixture (not shown). As shown in FIGS. 1A and 1B, the lateral spacing between the first and third fixed turn portions 101 and 103 can be adjusted to a first spacing distance S1 to accommodate a first workpiece WP1, e.g., a hollow pipe workpiece. The system is shown in FIGS. 2A and 2B with the lateral spacing between the first and third fixed turn portions 101 and 103 adjusted to a larger second spacing distance S2 to accommodate a larger diameter second workpiece WP2.

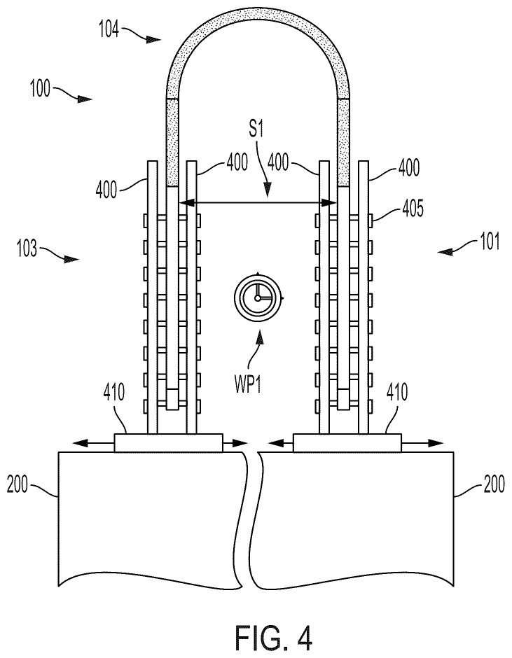

With reference to FIG. 4, an adjustable mounting apparatus or stand for the implementation of the presently described embodiments may take a variety of forms, as those of skill in the field will appreciate upon a reading of the present disclosure. As shown, a stand 200 to support and/or rotate a workpiece WP1 is shown in combination with the coil apparatus 100 which may be supported and adjusted in a variety of suitable manners. For example, in general, the mounting fixture or stand may include elements configured to manually adjust the spacing distance. As a further example, the mounting fixture or stand may include elements configured to adjust the spacing distance using machine control. In such an example, a control panel and suitable controller (not shown) may be provided to cooperate with suitable hardware to change the size or spacing to accommodate the workpiece.

As but one example, FIG. 4 shows the stand 200 supporting the coil apparatus 100. In this regard, the first and second fixed turn portions are each supported by support structures 400, e.g., non-conductive stud boards, along their lengths with connectors, studs or pins (such as example connector 405) being inserted through the structures 400 and between turns (e.g., copper tubes) of the fixed turn portions to secure the arrangement. In at least one form, the support structures also provide support for adjustment of the coil apparatus 100 as demonstrated in FIGS. 1A-2B. In this regard, in the example arrangement shown, the support structures 400 are connected to or engaged with base portions 410 that can be moved laterally, either manually or by machine control, using, for example, suitable hardware elements (e.g., slots, slides, pins, keys, rollers, bearings, rails, servo-controlled elements, . . . , etc.) to change the spacing distance between the fixed turn portions 101 and 103.

Using this arrangement, it will be appreciated that, in at least one form, the stand 200 and the coil apparatus 100 are separated so the workpiece may be loaded and then brought together for inductive heating. When the coil apparatus 100 (with, for example, the support structures 400 engaged therewith) is brought into engagement with the stand 200, the base portions 410 and/or the support structures 400 are connected to or engaged with the stand in suitable manners, for example, including manually and/or with the assistance of mechanical guides. It will be understood that the base portions may be connected to the support structures 400 or the stand 200 before engagement. In these types of arrangements, it will also be understood that the workpiece may be rotated or not rotated during the inductive heating process.

As noted, it will be appreciated that the configuration of FIG. 4 is merely an example of an environment for the presently described embodiments. Other configurations, environments and/or implementations may be realized. For example, the coil apparatus 100 may be supported by fixtures above the stand. In at least one form of such an example, the adjustment could be realized using a frame with adjustable components to achieve the objectives of the presently described embodiments.

Also, in operation, it should be appreciated that the coil apparatus 100 may be lowered around the workpiece for processing or the stand may be raised to move the workpiece into the coil for processing. Different orientations of the system than those shown herein are also contemplated. For example, the coil apparatus 100 could be positioned with the open end up (relative to the ground). In this case, likewise, a suitably oriented stand or fixture 200 may be lowered or the coil raised to engage for operation. Further, the presently described embodiments may be implemented in a system where the workpiece is not positioned on a stand or fixture but conveyed into the opening of the coil by suitable conveyance techniques and structures. These techniques or combinations thereof, or others, may be used to achieve the objectives of the presently described embodiments.

The exemplary embodiments have been described with reference to example elements, configurations, and techniques. Obviously, modifications and alterations to the exemplary embodiments will occur to others upon reading and understanding the preceding detailed description. It is intended that the exemplary embodiments be construed as including all such modifications and alterations insofar as they come within the scope of the appended claims or the equivalents thereof.

1. A system comprising:
a coil apparatus comprising a first fixed turn portion having a first end and a second end, a second fixed turn portion having a first and a second end, a first flexible turn portion having a first end and a second end, and a second flexible turn portion having a first end and a second end, wherein the first flexible turn portion is connected to the first ends of the first fixed turn portion and the second fixed turn portion and the second flexible turn portion is connected to the second ends of the first fixed turn portion and the second fixed turn portion, such that a spacing distance between the first fixed turn portion and the second fixed turn portion is adjustable to accommodate a size of a workpiece to be heated by the coil apparatus;
a power supply configured to provide controlled voltage and/or current to the coil apparatus; and
a cooling fluid supply configured to circulate cooling fluid in the coil apparatus.

2. The system as set forth in claim 1, wherein the first fixed turn portion and the second fixed turn portion each comprise at least one electrically conductive structure having an interior cavity configured to allow a flow of the cooling fluid therethrough.

3. The system as set forth in claim 2, wherein the at least one electrically conductive structure comprises at least one hollow copper tube.

4. The system as set forth in claim 1, wherein the first flexible turn portion and the second flexible turn portion each comprise at least one flexible electrical conductor structure surrounded by a non-conductive flexible material to allow a flow of the cooling fluid through and/or around the at least one flexible electrical conductor.

5. The system as set forth in claim 4, wherein the flexible electrical conductor structure comprises at least one of the following: multi-strand braided copper wire or Litz wire.

6. The system as set forth in claim 4, wherein the non-conductive flexible material comprises a rubber hose.

7. The system as set forth in claim 1, further comprising a workpiece stand or mounting fixture having elements configured to manually adjust the spacing distance.

8. The system as set forth in claim 1, further comprising a workpiece stand or mounting fixture having elements configured to adjust the spacing distance using machine control.

9. The system as set forth in claim 1, wherein the first fixed turn portion and the second fixed turn portion are configured to conduct electricity, produce electromagnetic fields, and allow circulation of the cooling fluid.

10. The system as set forth in claim 1, wherein the first flexible turn portion and the second flexible turn portion are configured to conduct electricity and allow circulation of the cooling fluid.

11. A coil apparatus comprising:
a first fixed turn portion having a first end and a second end;
a second fixed turn portion having a first and a second end;
a first flexible turn portion having a first end and a second end; and,
a second flexible turn portion having a first end and a second end,
wherein the first flexible turn portion is connected to the first ends of the first fixed turn portion and the second fixed turn portion and the second flexible turn portion is connected to the second ends of the first fixed turn portion and the second fixed turn portion, such that a spacing distance between the first fixed turn portion and the second fixed turn portion is adjustable to accommodate a size of a workpiece to be heated by the coil apparatus.

12. The apparatus as set forth in claim 11, wherein the first fixed turn portion and the second fixed turn portion each comprise at least one electrically conductive structure having an interior cavity configured to allow a flow of the cooling fluid therethrough.

13. The apparatus as set forth in claim 12, wherein the at least one electrically conductive structure comprises at least one hollow copper tube.

14. The apparatus as set forth in claim 11, wherein the first flexible turn portion and the second flexible turn portion each comprise at least one flexible electrical conductor structure surrounded by a non-conductive flexible material to allow a flow of the cooling fluid through and/or around the at least one flexible electrical conductor.

15. The apparatus as set forth in claim 14, wherein the flexible electrical conductor structure comprises at least one of the following: multi-strand braided copper wire or Litz wire.

16. The apparatus as set forth in claim 14, wherein the non-conductive flexible material comprises a rubber hose.

17. The apparatus as set forth in claim 11, wherein the spacing distance is adjusted manually.

18. The apparatus as set forth in claim 11, wherein the spacing distance is adjusted using machine control.

19. The apparatus as set forth in claim 11, wherein the first fixed turn portion and the second fixed turn portion are configured to conduct electricity, produce electromagnetic fields, and allow circulation of cooling fluid.

20. The apparatus as set forth in claim 11, wherein the first flexible turn portion and the second flexible turn portion are configured to conduct electricity and allow circulation of cooling fluid.
